(19) United States
(12) Patent Application Publication
(10) Pub. No.: US 2017/0310117 A1
(43) Pub. Date: Oct. 26, 2017

(54) Systems And Methods For Closed Loop Control For Wireless Power Transfer

(71) Applicants: Prasanna Sharadchandra Nirantare, Kharadi (IN); Milind Suresh Kothekar, Dombivli (IN); Birger Pahl, Milwaukee, WI (US)

(72) Inventors: Prasanna Sharadchandra Nirantare, Kharadi (IN); Milind Suresh Kothekar, Dombivli (IN); Birger Pahl, Milwaukee, WI (US)

(21) Appl. No.: 14/681,561

(22) Filed: Apr. 8, 2015

Related U.S. Application Data
(60) Provisional application No. 61/977,442, filed on Apr. 9, 2014.

(51) Int. Cl. H02J 5/00; H02M 7/44

(52) U.S. Cl. CPC H02J 5/005; H02M 7/44

(57) ABSTRACT

A wireless power transmitter for wirelessly transmitting a power for powering a load includes a direct-current to alternating-current (DC/AC) converter coupled to a direct-current (DC) power source. The wireless power transmitter further includes a resonant network coupled to an output of the DC/AC converter. The wireless power transmitter also includes an output estimation module coupled to the DC power source. The output estimation module estimates a power characteristic of a load to generate an estimated power characteristic of the load. The load is configured to be powered based on a transmitted power that is wirelessly transmitted by the wireless power transmitter. The wireless power transmitter further includes a control system coupled to the DC/AC converter. The control system controls the DC/AC converter to control an amount of the transmitted power based on the estimated power characteristic of the load.

### CROSS-REFERENCE TO RELATED APPLICATIONS

This application claims priority to U.S. Provisional Patent Application No. 61/977,442 titled, “Systems And Methods For Closed Loop Control For Wireless Power Transfer,” filed on Apr. 9, 2014, the entire content of which is incorporated herein by reference.

### TECHNICAL FIELD

The present disclosure generally relates to wireless power transfer technology, and more particularly to systems and methods for providing closed loop control of wireless power transfer.

### BACKGROUND

Wireless power transfer technology is used in many industries to transmit power from a source to a load without the need for power cables or wires. The source side may be interchangeably called the transmitting side or transmitter, and the load side may be interchangeably called the receiving side or receiver. For example, wireless power transfer technology can be used to transmit power from a power source to a lighting device. When using wireless power transfer to transmit power, it is important to control the amount of power provided to the load. Typically, in order to control an amount of power transmitted from the power source, voltage and/or current feedback is collected from the load or receiving side and transmitted to the transmitting side, wherein closed loop control or adjustment is performed based on the feedback transmitted from the receiving side. However, providing this feedback data from the receiver to the transmitter requires implementation of a communication protocol. The implementation of a communication protocol from the receiving side to the transmitting side requires additional software and hardware to be added to the system, increasing cost and bulk.

Thus, a system that allows wireless power transfer without the need for implementation of a communication protocol from the receiving side to the transmitting side is desirable.

### BRIEF DESCRIPTION OF THE FIGURES

Reference will now be made to the accompanying drawings, which are not necessarily drawn to scale, and wherein:

FIG. 1 illustrates a block diagram of a wireless power transfer system with closed loop control based on estimated feedback according to an example embodiment of the present disclosure.

FIG. 2A illustrates a block diagram of an output estimation process performed by the output estimation module of the system of FIG. 1 according to an example embodiment of the present disclosure;

FIG. 2B illustrates a block diagram of an output estimation process performed by the output estimation module of the system of FIG. 1 according to another example embodiment of the present disclosure;

FIG. 3 illustrates a block diagram of an output estimation process performed by the output estimation module of the system of FIG. 1 according to another example embodiment of the present disclosure;

FIG. 4 illustrates a block diagram of the output estimation module and control system of the wireless power transfer system of FIG. 1 according to another example embodiment of the present disclosure; and

FIG. 5 illustrates a block diagram of the control system of FIG. 1 according to an example embodiment of the present disclosure.

The drawings illustrate only example embodiments of the invention and are therefore not to be considered limiting of its scope, as the invention may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

### SUMMARY

The present relates to wireless power transfer technology for providing closed loop control of wireless power transfer. In an example embodiment, A wireless power transmitter for wirelessly transmitting a power for powering a load includes a direct-current to alternating-current (DC/AC) converter coupled to a direct-current (DC) power source. The wireless power transmitter further includes a resonant network coupled to an output of the DC/AC converter. The wireless power transmitter also includes an output estimation module coupled to the DC power source. The output estimation module estimates a power characteristic of a load to generate an estimated power characteristic of the load. The load is configured to be powered based on a transmitted power that is wirelessly transmitted by the wireless power transmitter. The wireless power transmitter further includes a control system coupled to the DC/AC converter. The control system controls the DC/AC converter to control an amount of the transmitted power based on the estimated power characteristic of the load.

In another example embodiment, a wireless power transfer system includes a power transmitting circuit coupled to a power source. The wireless power transfer system further includes a power receiving circuit. The power receiving circuit is coupled to a load. The power transmitting circuit wirelessly transmits a transmit power to the power receiving circuit. The wireless power transfer system also includes an output estimation module coupled to the power transmitting circuit. The output estimation module estimates a power characteristic of the load to generate an estimated power characteristic of the load. The wireless power transfer system further includes a control system coupled to the output estimation system and to the power transmitting circuit. The control system controls the power transmitting circuit based on the estimated power characteristic of the load to control an amount of the transmit power transmitted to the power receiving circuit.

In another example embodiment, a method of controlling a wireless power transfer system includes transmitting a power from a power transmitting circuit of the wireless power transfer system to a power receiving circuit of the wireless power transfer system. The power receiving circuit delivers the power to a load. The method further includes estimating a power characteristic of the load to generate an estimated power characteristic of the load. The method also includes controlling an amount of transmit power transmitted by the power transmitting circuit based on the estimated power characteristic of the load.

These and other aspects, objects, features, and embodiments will be apparent from the following description and the appended claims.

### DETAILED DESCRIPTION OF EXAMPLE EMBODIMENTS

Example embodiments disclosed herein are directed to systems and methods for providing closed loop control for wireless power transfer applications. Specifically, techniques disclosed herein provide solutions for such closed loop control without requiring an additional feedback communication protocol from the receiving side. The present disclosure provides a means of simulating feedback from the receiving side at the transmitter side, and allows the amount of transmitted power to be controlled according to the simulated feedback. This makes possible closed loop control without the additional hardware and costs associated with providing an additional communication protocol from the receiving side to the transmitting side. The example embodiments disclosed herein are also directed to lighting applications in which the load or receiving end comprises a lighting device, such as an LED lighting device. However, the systems and methods provided herein are applicable to any type of lighting device. Additionally, the systems and methods provided herein are applicable to other types of loads other than lights. In certain example embodiments, the systems and methods provided herein can be used in any type of load or application in which the distance between the power source and the load is fixed and in which the amount of power to be consumed by the load is constant as well.

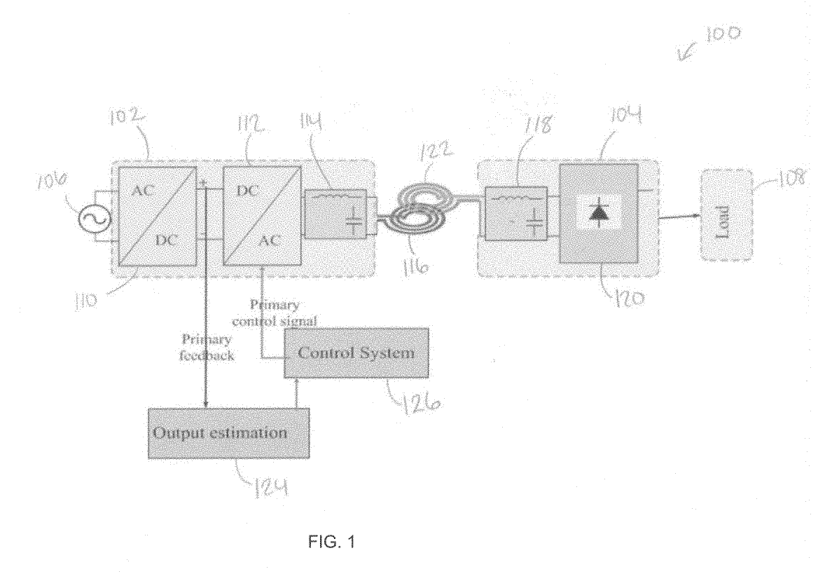

FIG. 1 illustrates a block diagram of a wireless power transfer system 100 with closed loop control based on estimated feedback according to an example embodiment of the present disclosure. Referring to FIG. 1, the system 100 includes a power transmitting circuit 102 and a power receiving circuit 104. The power transmitting circuit 102 is coupled to a power source 106 and the power receiving circuit is coupled to a load 108. In certain example embodiments, the power source 106 is an alternating-current (AC) source, as shown. In certain other example embodiments, the power source 106 is a direct-current (DC) source. In certain example embodiment, the load 108 is an LED light. In certain other example embodiments, the load 108 is another type of lighting device or another type of load other than lighting device.

In certain example embodiments, such as one in which the power source 106 is an AC source, the power transmitting circuit 102 includes an AC/DC converter 110 which converts the input AC power from the power source 106 into a DC signal, which can be used for digital data processing. In certain example embodiments, the power transmitting circuit 102 further includes a DC/AC converter 112 which converts the DC signal from the AC/DC converter 110 back into an AC signal. The power transmitting circuit 102 further includes a transmitter resonant network 114 which is coupled to a transmitter coil 116. Similarly, the power receiving circuit 104 includes a receiver resonant network 118. As shown in FIG. 1, a receiver coil 122 is coupled to the power receiving circuit 104. In some example embodiments, the transmitter resonant network 114 and the receiver resonant network 118 are standard components of wireless power transfer components that resonate with the transmitter coil 116 and the receiver coil 122 to enable wireless power transfer.

In certain example embodiments, the power receiving side 104 further includes a diode rectifier 120 which coupled to the output of the receiver resonant network 118 to convert AC power from the receiver resonant network 118 to DC power that is delivered to the load 108.

The power transmitting circuit 102 is coupled to an output estimation module 124 and a control system 126. The output estimation module 124 estimates one or more power characteristic (e.g., current, voltage, and/or power levels) of the load 108 and generates/outputs one or more estimated power characteristic (e.g., estimated current, voltage, and/or power levels) of the load 108. The control system 126 determines and controls the amount of power that is transmitted to the power receiving circuit 104 based on the estimated power characteristic(s) of the load 108 provided by the output estimation module 124 and other inputs as described in more detail below.

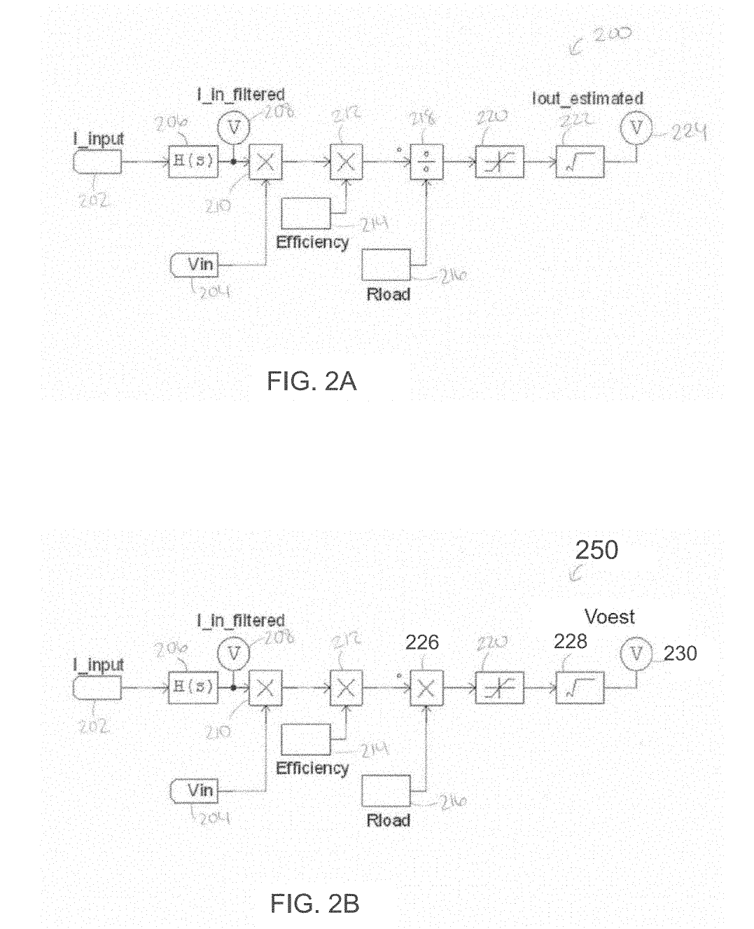

The output estimation module 124 can be implemented as an analog or digital system using hardware and/or software. The output estimation module 124 receives as input the output of the AC/DC converter 110. In certain example embodiments, the output estimation module 124 receives as input a DC reading of the power provided by the power source 106. For example, when the power source 106 is an AC source, the output estimation module 124 receives the output power of the AC/DC converter 110. In certain example embodiments, when the power source 106 is a DC source, the input to the output estimation module 124 comes directly from the output of the DC source. In general, the input to the output estimation module 124 is the current and/or voltage supplied to the DC/AC converter 112, which receives power from the power source 106 directly or through the AC/DC converter 110. In some example embodiments, the output estimation module 124 estimates the power level received at the load 108 based on the input from the voltage and/or current provided to the DC/AC converter 112 and other parameters. The steps implemented in the output estimation module 124 to estimate the power level received at the load 108 are described in more detail below with respect to FIGS. 2, 3, and 4.

Referring still to FIG. 1, in some example embodiments, the output estimation module 124 outputs an estimate of the current amount that is drawn by the load 108 from the power receiving circuit 104. Alternatively or in addition, the output estimation module 124 may output an estimate of the voltage level delivered to the load 108 by the power receiving circuit 104. In some example embodiments, the output estimation module 124 may output an estimate of the power drawn by the load 108 from the power receiving circuit 104. In general, the output estimation module 124 estimates the current, voltage and/or power level at the load 108 based on the input from the voltage and/or current provided to the DC/AC converter 112 and other parameters described below.

To illustrate with respect to the estimated current, because the estimated current value from the output estimation module 124 simulates the actual current drawn by the load 108 from the power receiving circuit 104, a reading of the actual power drawn by the load 108 is not required by the control system 126, which eliminates the need for a feedback communication channel from the load 108 to the control system 126. As described above, the control system 126 may receive the estimated current amount, the estimated voltage level and/or the power level as input from the output estimation module 124. The control system 126 uses the estimated value(s) instead of an actual feedback signal(s) from the load 108, which eliminates the need for transmitting the actual power characteristic parameter values (e.g., current, voltage, voltage) from to the control system 126.

The control system 126 determines and controls the amount of power to be transmitted over the coils 116, 122 to the power receiving circuit 104 based on the estimated power characteristic(s) of the load 108 received from the output estimation module 124. In certain example embodiments, the control system 126 provides power control to the power transmitting circuit 102 based on duty cycle, frequency, and/or any other appropriate form of power control. In general, the control system 126 can increase or decrease the amount of power transmitted from the power transmitting circuit 102 to the power receiving circuit 104 in order to deliver the desired amount of power to the load 108. In some example embodiments, the control system can maintain the voltage level provided to the load 108 when the input to the DC/AC converter changes. The control system 126 can be an analog controller or a digital controller.

The power transmitting circuit 102 and power receiving circuit 104 illustrated herein are example embodiments of basic circuit topologies which can be modified to specific applications. Thus, in other example embodiments, the power transmitting circuit 102 and the power receiving circuit 104 may include more or less electronic components arranged in other configurations than that shown. Particular configurations of the power transmitting circuit 102 and the power receiving circuit 104 may depend on the type of power supply 106 used, the type of load 108, certain performance criteria, and other design factors.

FIG. 2A illustrates a block diagram 200 of an output estimation process performed by the output estimation module 124 of the system 100 of FIG. 1 according to an example embodiment of the present disclosure. Referring to FIGS. 1 and 2A, the block diagram 200 illustrates estimation of the actual current drawn from the power receiving circuit 104 by the load 108. The output estimation module 124 can be implemented using hardware and/or software in the output estimation module 124. For example, the output estimation module 124 may be implemented using a DSP, an FPGA, an ASIC or a combination thereof. In certain example embodiments, the output estimation module 124 takes as inputs, an input current 202 and an input voltage 204. The input current 202 and the input voltage 204 are obtained from the DC output, either direct or converted from AC by the AC/DC converter 102, of the power source 106, as illustrated in FIG. 1.

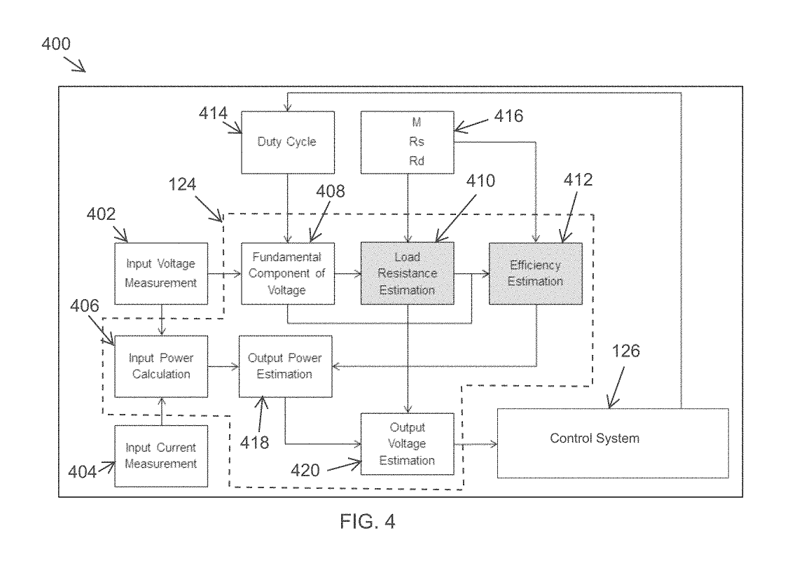

In certain example embodiments, the input current 202 is filtered through a filter function 206 (e.g., a low pass filter) in order to remove high frequency noise within the input current signal, for example, from the power source 106. In some example embodiments, the filtered input current 208 is obtained and used for the remaining calculations/operations. The input voltage 204 and the processed input current 208 are multiplied in step 210 (e.g., by a multiplier circuit) to calculate the power drawn from the power source 106. In certain example embodiments, the calculated power drawn is then multiplied (e.g., by a multiplier circuit) in step 212 with an efficiency value 214 of the system 100. In some example embodiments, the efficiency value 214 is a known parameter indicative of the efficiency between the power p and the actual power actually delivered to the load 108. In certain example embodiments, the efficiency value is determined during product development by testing the system 100. In alternative embodiments, the efficiency value 214 may be calculated as described below with respect to FIG. 4.

The output of the multiplication operation 212 is an estimate of the actual power received by the load 108. In some example embodiments, the output estimation module 124 may provide the estimated power information to the control system 126. In certain example embodiments, the estimate value of the power received by the load 108 is then divided at step 218 by the resistance value 216 of the load 108. In certain example embodiments, the resistance value 216 of the load 108 is also a known parameter. In alternative embodiments, the resistance value 216 of the load 108 may be calculated/estimated as described below with respect to FIG. 4.

In certain example embodiments, the resistance of the load 108 may not be linear, such as in certain LED applications. Thus, in some example embodiments, a lookup table can be used to obtain accurate resistance values. In certain example embodiments, the output of the multiplier operation 218 further processed through one or more operations such as a value limiter step 220. The estimate of the current drawn by the load 108 is output by a square root step 222 as the estimated load current (Iout_estimated) 224. The estimated load current 224 can be provided to the control system 126 as described above.

The control system 126 uses the estimated load current 224 instead of direct feedback information transmitted to the controller system 126 from the load 108 to control the power transmitting circuit 102 accordingly in order to establish and/or maintain the desired current and/or power level at the load 108. In certain example embodiments, the estimated load current 224 is given a tolerance of +/−5%. This tolerance is given partially due to part to part variation of the load 108 or other components in the circuit, load resistance, and coupling effects, which may have an effect of the actual efficiency value 214.

FIG. 2B illustrates a block diagram 250 of an output estimation process performed by the output estimation module 124 of the system 100 of FIG. 1 according to another example embodiment of the present disclosure. Referring to FIGS. 1 and 2A, the block diagram 250 illustrates estimation of the actual voltage provided to the load 108 from the power receiving circuit 104. The primary differences between the block diagram 250 and the block diagram 200 of FIG. 2A are operations 226 and 222 of the block diagram 250 of FIG. 2B. In FIG. 2B, the output of the multiplier operation 212 is multiplied by the resistance value 216 of the load 108. The estimate of the power provided to the load 108 from the power receiving circuit 104 is output by a square root step 228 as the estimated load voltage (Voest) 230. As described with respect to FIG. 2A, the efficiency value 214 and the resistance value 216 may be known parameters or may be estimated/calculated.

Although particular sequences of operation are shown in FIGS. 2A and 2B, in some alternative embodiments, other sequences of operation may be performed to generate the estimated load current (Iout_estimated) 224 and the estimated load voltage (Voest) 230. Further, block diagrams 200, 250 of the output estimation module 124 may include operations other than shown in FIGS. 2A and 2B.

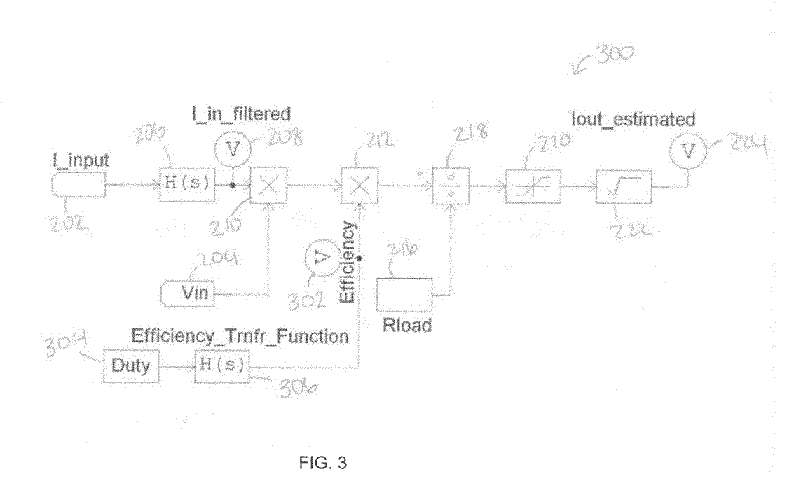

FIG. 3 illustrates a block diagram of an output estimation process 300 performed by the output estimation module 124 of the system 100 of FIG. 1 according to another example embodiment of the present disclosure. In certain example applications, power fluctuations may occur in the power source 106 and/or power characteristics of the load 108 could fluctuate or change over time. For example, the power efficiency of an LED lighting device could degrade over time or due to high temperature. In some example embodiments, the efficiency of the system 100 may be calculated by the output estimation module 124 instead of pre-determined, for example, based on test data.

The block diagram of the output estimation process 300 can be implemented with hardware and/or software in the output estimation module 124. The primary difference between the block diagram of the output estimation processes 200 and 300 is related to the calculation of the efficiency parameter. The block diagram of the output estimation processes 300 is similar to the block diagram of the output estimation processes 200 illustrated in FIG. 2 with the exception of a dynamic efficiency parameter 302, rather than the constant efficiency parameter 214. In certain example embodiments, the efficiency parameter 302 is derived through an efficiency transfer function 306 and a control signal 304.

In certain example embodiments, the control signal 304 is the output of the control system 126 which is used to increase or decrease the power supplied by the power transmitting circuit 102. Therefore, if the control signal 304 falls out of a specified range, it may be indicative of a change in the power characteristics (e.g., current, voltage, etc.) of the load 108 or the power supply 106. The efficiency transfer function 306 determines the actually efficiency parameter 302 based on the control signal 304. Specifically, the transfer function 306 includes a relationship between the control signal 304 value and the efficiency value 302. Thus, the efficiency parameter 302 is constantly updated to compensate for changes in the power characteristics of the power source 106 or the load 108. In certain example embodiments, the control signal 304 is based on a duty cycle or another form of power control signal. In certain example embodiments, the efficiency transfer function 306 is based on an algorithm or a look-up table.

FIG. 4 illustrates a block diagram of the output estimation module 124 and the control system 126 of the wireless power transfer system 100 of FIG. 1 according to another example embodiment of the present disclosure. Referring to FIGS. 1 and 4, the output estimation module 124 performs estimation the voltage provided to the load 108 based on efficiency value and resistance value of the load that are calculated and/or estimated by the output estimation module 124 as described below.

Input voltage measurement block 402 performs measurement of the input voltage provided to the DC/AC converter 112 of FIG. 1. For example, a sensor circuit may be to determine the voltage level. The input current measurement block 404 performs measurement of the input current provided to the DC/AC converter 112 of FIG. 1. As described with respect to the FIG. 1, the input voltage and the input current are DC voltage and DC current, respectively, and may be provided directly by the AC/DC converter 110 or by the power source 106, when the power source 106 is a DC power source. In some example embodiments, the block 402 and 404 may be part of the output estimation module 124.

In some example embodiments, the input power calculation block 406 performs input power calculation based on the measured input voltage from the block 402 and the input current from the block 404. The output of the block 406 is provided to the output power estimation block 418 to estimate the power drawn by the load 108. The fundamental component of voltage block 408 determines the fundamental voltage component of the output of the DC/AC converter 112 of FIG. 1. In some example embodiments, Equation 1 may be used to determine the fundamental voltage component.

$${V}_{i} = \frac{\sqrt{2} {V}_{DC}}{π} Sin ( π D ) \qquad Eq . 1$$

In Equation 1, Vᵢ is the RMS value of the fundamental component of the output voltage of the DC/AC converter 112. V_{DC} is the DC value of the voltage at the input of the DC/AC converter 112. D in Equation 1 is the duty cycle of the output voltage/current at the output of the DC/AC converter 112 as determined by the control system 126 to control the output power of the DC/AC converter 112. The duty cycle block 414 represents the duty cycle, D, being provided to the block 408.

The fundamental component Vᵢ is provided to the load resistance estimation block 410 for use in determining the resistance of the load 108. In some example embodiments, the resistance of the load 108 may be determined by the block 410 based on equations 2 and 3 below.

$$\begin{matrix}Pi = \frac{{( Vi )}^{2} . {R}_{w \_} i}{[ {R}_{s} ( {R}_{D} + {R}_{w \_} i ) + {( ω M )}^{2} ]} & Eq . 2 \\ {R}_{w} = \frac{{( π )}^{2}}{8} {R}_{w \_} i & Eq . 3\end{matrix}$$

Equation 2 is used to calculate/estimate R_{w}_{_}ᵢ, which is the equivalent of the resistance of the load 108 as reflected at the input of rectifier 120. In Equation 2, Pᵢ is the power at the input of the DC/AC converter 112, which may, for example, be determined by the block 406. Rs and Rd are the transmitter side and receiver side resistances, respectively, which are the characteristic of the designed system 100 and are thus known values. M is the mutual inductance between the electrical coils 116 and 122 and is a known parameter for a given fixed distance system. Block 416 represents Rs, Rd, and M being provided to the block 410. ω is the frequency of the output voltage/current of the DC/AC converter 112 and corresponds to the resonance frequency of the transmitter resonant network 114 and the coil 116 as well as the resonance frequency of the receiver resonant network 118 and the coil 118. R_{w}_{_}ᵢ is the equivalent of the resistance of the load 108 as reflected at the input of rectifier 120. In Equation 3, the R_{w}_{_}ᵢ is used to calculate the resistance, R_{w}, of the load 108.

After R_{w}_{_}ᵢ is calculated, the efficiency parameter of the system 100 may be estimated by the efficiency estimation block 412 based on Equation 4.

$$η = \frac{{( ω M )}^{2} . {R}_{w \_} i}{( {R}_{w \_} i + {R}_{D} ) [ {R}_{s} ( {R}_{D} + {R}_{w \_} i ) + {( ω M )}^{2} ]} \times 100 \% \qquad Eq . 4$$

In Equation 4, η is the efficiency parameter of the system and is used by the output power estimation block 418 to estimate the power provided from the power receiving circuit 104 to the load 108. For example, the output power estimation block 418 may perform a multiplication (e.g., using a multiplier circuit) of the input power calculated by the input power calculation block 406 and the efficiency parameter, η. In some example embodiments, the output voltage estimation block 420 may calculate voltage provided to the load 108 based on the calculated/estimated load resistance, R_{w}, from the load resistance estimation block 410 and the estimated output power from the output power estimation block 418. Alternative or in addition to the output voltage estimation block 420, a current estimation block (not shown in FIG. 4) may be used to calculate/estimate the current drawn by the load 108 based on the calculated/estimated load resistance, R_{w}, from the load resistance estimation block 410 and the estimated output power from the output power estimation block 418. The output voltage estimated/calculated by the block 420 is provided to the control system 126. As described above, one or more outputs of the control system 126 are provided to the DC/AC converter 126 to control the power transmitted by the power transmitter circuit 102.

By calculating/estimating the current drawn by the load 108 or the voltage provided to the load 108 based on the calculated efficiency and load resistance parameters, the system 100 can control the power transmitted by the power transmitting circuit 102 to accommodate, for example, changes in the power characteristic (e.g., the current drawn by the load 108 or the voltage at the input of the load 108). By calculating/estimating the current and/or power at the load 108 at the power transmitting side, feedback communication from the load 108 or from the power receiving circuit 104 to the control system 126 and the associated hardware and/software can be avoided.

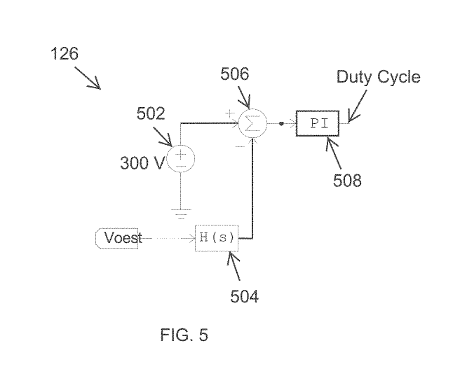

FIG. 5 illustrates a block diagram of the control system 126 of FIGS. 1 and 4 according to an example embodiment of the present disclosure. In FIG. 5, the control system 126 is designed to deliver 300 Volts to load 108 of FIG. 1. Referring to FIGS. 1 and 5, in some example embodiments, the control system 126 may receive estimated output voltage (Voest), i.e., the estimate of the voltage that is provided to the load 108, for example, from the output load estimation block 420 of FIG. 4. In some example embodiments, the estimated output voltage (Voest) may be filtered by block 504. Block 506 determines the difference between the 300 V that is desired to be provided to the load 108 and the filtered estimated output voltage (Voest). The block 508 may generate the duty cycle output based on the input from the block 506. The duty cycle output may be provided to the block 408 in FIG. 4. The duty cycle output is also provided to the DC/AC converter 112 to control the output voltage provided by the DC/AC converter 112. In alternative embodiments, a desired current amount to be provided to the load 108 may be used instead of the desired voltage (i.e., the example 300 V used in this FIG. 5).

Although the inventions are described with reference to example embodiments, it should be appreciated by those skilled in the art that various modifications are well within the scope of the invention. From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the example embodiments, equivalents of the elements shown therein will suggest themselves to those skilled in the art, and ways of constructing other embodiments of the present invention will suggest themselves to practitioners of the art. Therefore, the scope of the present invention is not limited herein.

What is claimed is:

1. A wireless power transmitter for wirelessly transmitting a power for powering a load, the wireless power transmitter comprising:
a direct-current to alternating-current (DC/AC) converter coupled to a direct-current (DC) power source;
a resonant network coupled to an output of the DC/AC converter;
an output estimation module coupled to the DC power source, wherein the output estimation module estimates a power characteristic of a load to generate an estimated power characteristic of the load and wherein the load is configured to be powered based on a transmitted power that is wirelessly transmitted by the wireless power transmitter; and
a control system coupled to the DC/AC converter, wherein the control system controls the DC/AC converter to control an amount of the transmitted power based on the estimated power characteristic of the load.

2. The wireless power transmitter of claim 1, further comprising an electrical coil coupled to the resonant network.

3. The wireless power transmitter of claim 1, wherein the DC power source is an alternating-current to direct-current (AC/DC) converter coupled to an alternating-current (AC) power source that provides input power to the AC/DC converter.

4. The wireless power transmitter of claim 1, wherein the power characteristic of the load is estimated based on an input power provided to the DC/AC converter, an efficiency parameter, and a resistance of the load.

5. The wireless power transmitter of claim 4, wherein the efficiency parameter is determined based on test data and wherein the test data includes the input power provided to the DC/AC converter and a load power provided to the load.

6. The wireless power transmitter of claim 4, wherein the efficiency parameter is determined by the output estimation module based on a characteristic of the input power provided to the DC/AC converter and wherein the characteristic of the input power changes in response to a change in the power characteristic of the load.

7. The wireless power transmitter of claim 6, wherein the characteristic of the input power includes an amount of the input power and wherein the estimated power characteristic of the load includes an estimate of a current amount drawn by of the load or a voltage across the load.

8. A wireless power transfer system, comprising:
a power transmitting circuit coupled to a power source;
a power receiving circuit, wherein the power receiving circuit is coupled to a load and wherein the power transmitting circuit wirelessly transmits a transmit power to the power receiving circuit;
an output estimation module coupled to the power transmitting circuit, wherein the output estimation module estimates a power characteristic of the load to generate an estimated power characteristic of the load; and
a control system coupled to the output estimation system and to the power transmitting circuit, wherein the control system controls the power transmitting circuit based on the estimated power characteristic of the load to control an amount of the transmit power transmitted to the power receiving circuit.

9. The wireless power transfer system of claim 8, further comprising a transmit electrical coil and a receive electrical coil, wherein the power transmitting circuit transmits the transmit power via the transmit electrical coil and wherein the receive electrical coil receives the transmit power via the receive electrical coil.

10. The wireless power transfer system of claim 8, wherein the power characteristic of the load is estimated based on an input power provided to the power transmitting circuit by the power source, an efficiency parameter, and a resistance of the load.

11. The wireless power transfer system of claim 10, wherein the power source is an alternating-current (AC) power source.

12. The wireless power transfer system of claim 10, wherein the power source is a direct-current (DC) power source.

13. The wireless power transfer system of claim 10, wherein the power transmitting circuit comprises:
a direct-current to alternating-current (DC/AC) converter coupled to the power source and to the control system, wherein the control system controls the DC/AC converter based on the estimated power characteristic of the load; and
a resonant network coupled to an alternating-current (AC) output of the DC/AC converter.

14. The wireless power transfer system of claim 10, wherein the efficiency parameter is determined based on test data and wherein the test data includes the input power provided to the DC/AC converter and a load power provided to the load.

15. The wireless power transfer system of claim 10, wherein the efficiency parameter is determined by the output estimation module based on a characteristic of the input power provided to the DC/AC converter and wherein the characteristic of the input power changes in response to a change in the power characteristic of the load.

16. The wireless power transfer system of claim 15, wherein the characteristic of the input power includes an amount of the input power and wherein the power characteristic of the load includes an amount of a current drawn by of the load or a voltage across the load.

17. The wireless power transfer system of claim 8, wherein the load includes a light emitting diode of a lighting fixture.

18. A method of controlling a wireless power transfer system, the method comprising:
transmitting a power from a power transmitting circuit of the wireless power transfer system to a power receiving circuit of the wireless power transfer system, wherein the power receiving circuit delivers the power to a load;
estimating a power characteristic of the load to generate an estimated power characteristic of the load; and
controlling an amount of transmit power transmitted by the power transmitting circuit based on the estimated power characteristic of the load.

19. The method of claim 18, wherein estimating a power characteristic of the load includes estimating an amount of a current drawn by of the load.

20. The method of claim 18, wherein controlling the amount of transmit power includes adjusting a duty cycle of an output signal of the power transmitting circuit.
